(19) United States
(12) Patent Application Publication
(10) Pub. No.: US 2026/0085578 A1
(43) Pub. Date: Mar. 26, 2026

(54) AIRCRAFT HAVING STOWABLE LADDER FOR COCKPIT ACCESS

(71) Applicant: Government of the United States as represented by the Secretary of the Air Force, Wright-Patterson AFB, OH (US)

(72) Inventor: Nicholas Atkins, Sacile (IT)

(21) Appl. No.: 18/895,116

(22) Filed: Sep. 24, 2024

(51) Int. Cl. E06C 1/52; B64D 9/00; E06C 7/50

(52) U.S. Cl. CPC E06C 1/52; B64D 9/00; E06C 7/505

(57) ABSTRACT

A hinged ladder for ascending to and descending from a cockpit of an aircraft and method of using the ladder for access to and egress from the cockpit. The ladder is suspended from an anchor which supports the combined weight of the ladder and a user. The ladder comprises a plurality of rung plates connected by hinges. The rung plates have respective holes to accept the foot of a user. In use, the ladder is suspended from an anchor in use, and extends longitudinally. The ladder has a standoff to provide single point contact against a fuselage of the aircraft, preventing damage during use. The standoff may articulate outwardly from a rung plate about an X axis. The standoff may be braced by paired struts which articulate about respective Y axes, preventing collapse of the standoff. Each strut may be locked in position by a respective latch which articulates about a respective Z axis.

### STATEMENT OF GOVERNMENT INTEREST

The invention described and claimed herein may be manufactured, licensed and used by and for the Government of the United States of America for all government purposes without the payment of any royalty.

### FIELD OF THE INVENTION

The present invention is related to a non-self-supporting ladder usable for access to and egress from an open cockpit aircraft, particularly to such a ladder which can be stored in a compact configuration, and more particularly to such a ladder which can assume dual shapes.

### BACKGROUND OF THE INVENTION

Referring to FIG. 1A, the F-16 aircraft 60 is a 4th generation, straked 63 fuselage 61, single engine, supersonic aircraft 60. The F-16 aircraft 60 was built under a consortium between the United States, Belgium, Denmark, the Netherlands, Norway and later Portugal, using more than 600 suppliers. The F-16A aircraft 60 is a single-seat model and first flew at Edwards Air Force Base in January, 1974. The first operational F-16A was delivered in January 1979 to the 388th Tactical Fighter Wing at Hill Air Force Base, Utah. The F-16B aircraft 60 is a two-seat model with tandem cockpits 62. The primary contractor is Lockheed Martin, after merger with General Dynamics. The power plants are sourced from both General Electric and Pratt and Whitney, providing a ceiling of 50000 feet and a maximum takeoff weight of 37500 pounds. This aircraft 60, and particularly the wings 66 and tail 67 thereof, are generally symmetrical about a centerline CL. Proximate, and preferably inside the cockpit 62 is an anchor 64. The anchor 64 is usable for stably suspending objects therefrom. The cockpit 62 also has a map compartment 65. With the advent and use of GPS, the map compartment 65 is lees useful for maps and more opportune for other uses as described below. The F-16A/B aircraft 60 are used by both the Air Force and Navy.

The F-16 aircraft 60 is further described in U.S. Pat. No. 4,869,443 to Skow, incorporated herein by reference. The F-16 fuselage 61 includes strakes 63, which are further described in NASA Contractor Report 3053, Aerodynamic of Forebody and Nose Strakes Based on F-16 Wind Tunnel Test Experience, by Smith et al. on July, 1979, incorporated herein by reference.

Referring to FIG. 1B, the cockpit of the F-16 is accessed by a cockpit boarding ladder 19, NSN: 1730-01-390-4570, PN 9646524. This prior art ladder 19 has a fixed, dogleg configuration and is used by persons 50 including both the pilot and copilot, if any. This prior art ladder 19 costs $5200 each, is heavy, is bulky leading to potential fuselage 61 coating damage if not expertly handled and must be pre-positioned as cargo before the F-16 aircraft 60 can be deployed.

But despite the F-16 aircraft 60 having hundreds of suppliers and being used in multiple countries, the problems with the prior art ladder 19 have persisted since the initial flight more than a half century ago. Clearly a solution is needed to provide a cockpit 62 access and egress which is less bulky and less expensive the prior art ladder 19, all while protecting the fuselage 61 coating, all without pre-positioning. Accordingly, it is an object of this invention to provide such cockpit 62 access and egress.

### SUMMARY OF THE INVENTION

In one embodiment the invention comprises a ladder with mutually perpendicular X, Y and Z axes. The ladder has hingedly connected rung plates to accept the foot of a person ascending and descending the ladder. The ladder has a standoff to provide single point contact against a fuselage of the aircraft, preventing damage. The standoff may articulate outwardly from a rung plate about the X axis. The standoff may be braced by paired struts which articulate about respective Y axes, preventing collapse of the standoff. Each strut may be locked in position by a respective latch which articulates about a respective Z axis.

In one embodiment the invention comprises an open cockpit aircraft in combination with a non-self-supporting ladder for access thereto and egress therefrom and comprising: the aircraft having a fuselage and an anchor proximate thereto and the longitudinally elongatable ladder comprising a plurality of hingedly connected rung plates, each rung plate having two opposed hinge edges with hinges disposed thereon and configured to fanfold the plurality of rung plates into a footprint, each rung plate having a hole therethrough and a first rung plate joined to a second rung plate of the plurality of rung plates, the first rung plate having an attachment for suspending the ladder from the anchor.

In one embodiment the invention comprises an open cockpit aircraft in combination with a non-self-supporting ladder for access thereto and egress therefrom and comprising: a ladder removably joinable to the outside of an aircraft to provide personnel access and egress into and out of a cockpit thereof and having a longitudinal axis and a transverse direction perpendicular thereto: the aircraft having a fuselage, an anchor proximate thereto and an external strake; and the ladder comprising a plurality of hingedly connected rung plates, each rung plate having two opposed hinge edges with hinges disposed thereon and configured to fanfold the plurality of rung plates into a footprint, each rung plate having two opposed side edges connecting the two opposed hinges edges to define a respective footprint therebetween, and a hole therethrough for accepting a person's foot when climbing up or down the ladder, a second rung plate of the plurality of rung plates being hingedly joined to the first rung plate, the other rung plates successively depending from the second rung plate and a respective rung plate having a standoff joined thereto and being disposed wholly within the footprint, whereby the ladder is removably suspendable from the cockpit with only a single, predetermined contact with a fuselage of the aircraft at the standoff.

In one embodiment the invention comprises n open cockpit aircraft in combination with a non-self-supporting ladder for access thereto and egress therefrom and comprising: the aircraft having a fuselage and an anchor proximate thereto; and at least two hingedly connected rung plates, each of the at least two rung plates having a hole therethrough, the hole having a bottom edge configured to allow a person's foot to temporarily rest thereupon; a standoff joined to a predetermined, generally planar rung plate by a standoff hinge, whereby the standoff can articulate from a standoff retracted position generally lying within the plane of the predetermined, generally planar rung plate to a standoff extended position for preventing the ladder from contacting a fuselage except at the standoff, whereby the rung plates can fold into a fanfold footprint when the standoff is in the retracted position; and at least two hingedly connected rung plates, each of the at least two rung plates having a hole therethrough for accepting a person's foot during climbing and having opposed inward and outward faces; a standoff joined to a predetermined, generally planar rung plate by a standoff hinge, whereby the standoff can articulate from a standoff retracted position generally lying within the plane of the predetermined, generally planar rung plate to a standoff extended position for preventing the ladder from contacting a fuselage except at the standoff, whereby the rung plates can fold into a fanfold footprint when the standoff is in the retracted position; a pair of mutually opposed struts lying within the plane of the predetermined, generally planar rung plate in a strut retracted position and extending outwardly towards the fuselage in a strut extended position, whereby the ladder is fanfoldable into a footprint no bigger than the footprint of the largest rung plate and a means to suspend the rung plates from an anchor associated with an aircraft.

### BRIEF DESCRIPTION OF THE DRAWINGS

All of the figures are to scale, except schematic FIG. 1A, schematic FIG. 2D and FIGS. 16-19 directed to a method according to the present invention.

FIG. 1A is a schematic top plan view of a F-16 aircraft.

FIG. 1B is a perspective view of an aircraft ladder according to the prior art.

FIG. 2A is a front elevational view of a ladder according to the present invention.

FIG. 2B is a rear elevational view of a ladder according to the present invention.

FIG. 2C is a front elevational view of an indeterminant length ladder according to the present invention.

FIG. 2D is a schematic side elevational view of a ladder in a partially open fanfolded configuration.

FIG. 3A is a perspective view of rung plate 1 for a ladder according to the present invention.

FIG. 3B is a top plan view of the rung plate 1 of FIG. 3A.

FIG. 3C is another perspective view of the rung plate 1 according to FIG. 3A having a strap.

FIG. 3D is a frontal view of the rung plate 1 of FIG. 3C.

FIG. 3E a top plan view of the rung plate 1 of FIG. 3C.

FIG. 3F is a top plan view of a blank usable to form the rung plate 1 of FIGS. 3A-3D.

FIG. 4A is a perspective view of rung plate 2 according to the present invention.

FIG. 4B is a frontal view of the rung plate 2 of FIG. 4A.

FIG. 4C is a top plan view of the rung plate 2 of FIG. 4A.

FIG. 4D is a top plan view of a blank usable to form the rung plate 2 of FIGS. 4A-4C.

FIG. 5A is a perspective view of rung plate 3 according to the present invention.

FIG. 5B is a frontal view of the rung plate 3 of FIG. 5A.

FIG. 5C is a top plan view of the rung plate 3 of FIG. 5A.

FIG. 5D is a top plan view of a blank usable to form the rung plate 3 of FIGS. 5A-5C.

FIG. 6A is a perspective view of rung plate 4 according to the present invention.

FIG. 6B is a frontal view of the rung plate 4 of FIG. 6A.

FIG. 6C is a top plan view of the rung plate 4 of FIG. 6A.

FIG. 6D is a top plan view of a blank usable to form the rung plate 4 of FIGS. 6A-6C.

FIG. 7A is a perspective view of rung plate 5 according to the present invention.

FIG. 7B is a frontal view of the rung plate 5 of FIG. 7A.

FIG. 7C is a top plan view of the rung plate 5 of FIG. 7A.

FIG. 7D is a top plan view of a blank usable to form the rung plate 5 of FIGS. 7A-7C.

FIG. 8A is a perspective view of rung plate 6 according to the present invention.

FIG. 8B is a frontal view of the rung plate 6 of FIG. 6A.

FIG. 8C is a top plan view of the rung plate 6 of FIG. 6A.

FIG. 8D is a top plan view of a blank usable to form the rung plate 6 of FIGS. 8A-8C.

FIG. 9A is a perspective view of rung plate 7 according to the present invention.

FIG. 9B is a frontal view of the rung plate 7 of FIG. 9A.

FIG. 9C is a top plan view of the rung plate 7 of FIG. 9A.

FIG. 9D is a top plan view of a blank usable to form the rung plate 7 of FIGS. 9A-9C.

FIG. 10A is a perspective view of a standoff for use with a ladder according to the present invention.

FIG. 10B is a frontal view of the standoff of FIG. 10A.

FIG. 10C is a top plan view of the standoff of FIG. 10A.

FIG. 10D is a bottom plan view of the standoff of FIG. 10A.

FIG. 11A is a perspective view of a strut usable with the ladder of the present invention.

FIG. 11B is a frontal view of the single strut of FIG. 11A.

FIG. 11C is a perspective view of a latch according to the present invention.

FIG. 11D is a frontal view of the latch of FIG. 11C.

FIG. 12A is a perspective view of a lock plate according to the present invention.

FIG. 12B is a front elevational view of the lock plate of FIG. 12A.

FIG. 12C is a side elevational view of the lock plate of FIG. 12A.

FIG. 12D is a top plan view of a blank usable to form the lock plate of FIGS. 12A-12C.

FIG. 13A is a perspective view of a ladder according to the present invention in a folded configuration.

FIG. 13B is a top plan view of a ladder according to the present invention in a folded configuration.

FIG. 14A is a perspective view of a person deploying a ladder from the cockpit of a F-16 aircraft.

FIG. 14B is a fragmentary perspective view of the ladder of FIG. 14A removably joined to an F-16 aircraft.

FIG. 14C is an enlarged fragmentary perspective view of the ladder of FIG. 14B taken at circle 14C.

FIG. 14D is an alternative perspective view of an alternative embodiment of a ladder removably joined to a fuselage of a F-16 aircraft.

FIG. 15A is a fragmentary perspective view of a first step in deploying a ladder according to the present invention.

FIG. 15B is a fragmentary perspective view of a second step in deploying a ladder according to the present invention, showing articulation of the standoff.

FIG. 15C is a fragmentary perspective view of a third step in deploying a ladder according to the present invention showing further articulation of the standoff.

FIG. 15D is a fragmentary perspective view of a fourth step in deploying a ladder according to the present invention showing yet further articulation of the standoff.

FIG. 15E is a fragmentary perspective view of a fifth step in deploying a ladder according to the present invention showing the lock plate in the extended position.

FIG. 15F is another fragmentary perspective view of the fifth step in deploying a ladder according to the present invention showing the lock plate in the extended position.

FIG. 15G is an enlarged fragmentary perspective view of a ladder according to the present invention showing the lock plate, standoff and struts in respective extended positions.

FIG. 16 is a series of steps in a method according to one aspect of the invention.

FIG. 17 is a series of steps in a method according to one aspect of the invention.

FIG. 18 is a series of steps in a method according to one aspect of the invention.

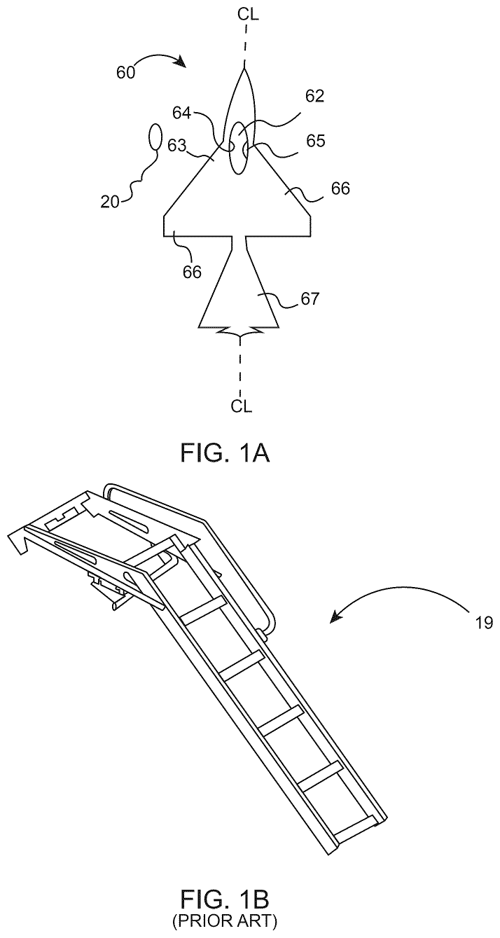

### DETAILED DESCRIPTION OF THE INVENTION

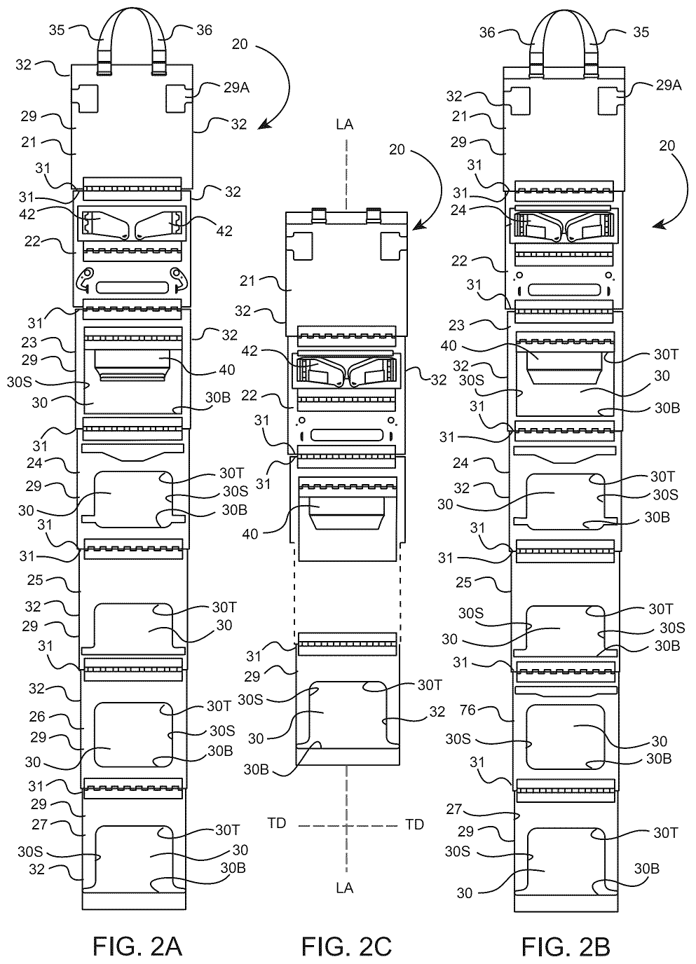

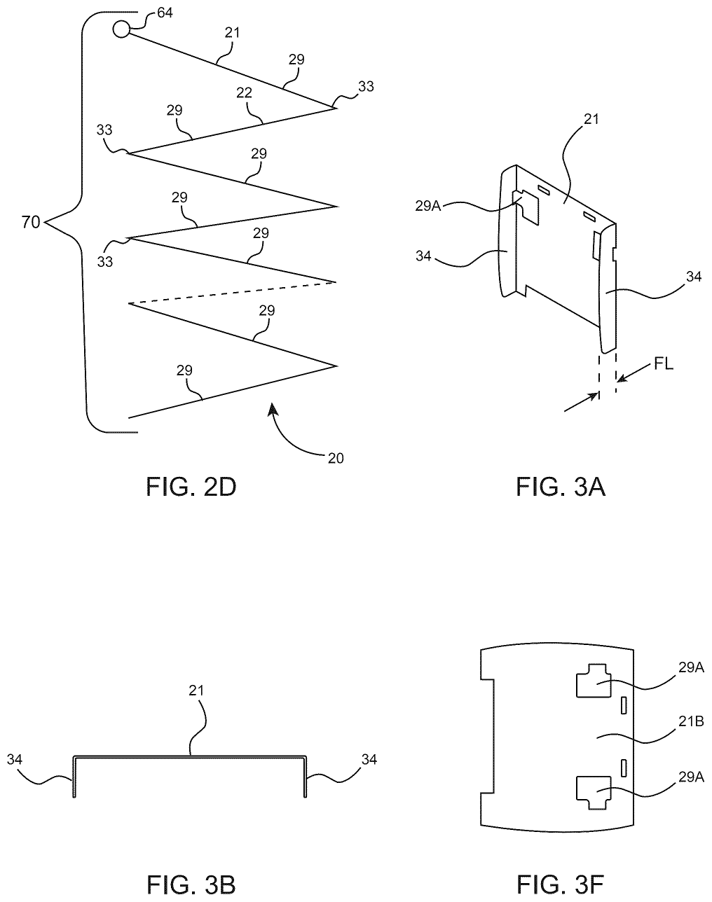

Referring to FIGS. 2A-2C, a ladder 20 according to the present invention is longitudinally elongate in a direction parallel to a longitudinal axis LA, with a transverse direction TD perpendicular thereto. The ladder 20 is shown in a generally vertical, and extended configuration, as ready for use by a person 50 desiring access into or egress from the cockpit 62. Such person 50 may be a pilot, maintainer, crew chief, etc. The ladder 20 comprises a plurality of hingedly connected rung plates 29.

The ladder 20 according to the present invention is non-self-supporting. By non-self-supporting it is meant the at the ladder 20 cannot stand on the ground in an extended configuration. A non-self-supporting ladder 20 must be suspended from an attachment 35 as described below for a person 50 to ascend the ladder 20 towards the cockpit 62 or to descend the ladder 20 towards the ground. Furthermore, the ladder 20 according to the present invention does not have a platform, further conserving space.

The ladder 20 may have at least three or five individual rung plates 29, but preferably not more than nine or 11 rung plates 29, as dictated by the height of the cockpit 62 above the ground plane. A ladder 20 with seven rung plates 29 has been found to work well for an F-16 aircraft 60. he rung plates 29, and associated components are rigid to not unduly deflect in use, provide for a fixed footprint within opposed flaps 34 and provide for a transversely centered standoff 41. The rung plate 29 may be made of aluminum, particularly 0.09 inch Type 5052 aluminum plate. As used herein a plate is given its normal meaning as used in fabrication and is distinguishable from and does not include rods, tubes, rails, beams, Nylon straps or the like\.

Each rung plate 29 is joined to an adjacent rung plate 29 by alternatingly foldable hinges 33, preferably piano hinges 33. The hinges 33 are operatively disposed on longitudinally spaced hinges edges 31 of each rung plate 29. The hinge edges 31 define the length of the rung plate 29 therebetween, may be parallel to the transverse direction TD and generally horizontal when the ladder is in use. Each rung plate 29 also has transversely spaced side edges 32, which define the width of the rung plate 29 therebetween. The side edges 32 may be generally vertical when the ladder 20 is in use.

As used herein a first rung plate 21 is also referred to as rung plate 1 21. A second rung plate 22 is also referred to as rung plate 2 22. A third rung plate 23 is also referred to as rung plate 3 23. Etc. Each rung plate 29 has an inner surface which faces towards the aircraft 60 when in use and an outer surface opposed thereto and which faces away from the aircraft 60 in use. A person 50 ascending or descending the ladder 20 in use approaches and climbs the ladder 20 from the outer surface.

Each rung plate 29 has a hole 30 therethrough. The hole 30 is sized in both the longitudinal dimension and transverse dimension to allow either the left foot, the right foot or both feet of a person 50 to rest with his/her weight thereon when the ladder 20 is in use. The holes 30 may have different geometries, as shown. A particular rung plate 29 may have two or more holes 30 if appropriately sized to accept a person's 50 foot.

Referring to FIG. 2D, the alternatingly folding hinges 33 enable the ladder 20 to be fanfolded into a compact footprint. The fanfolded configuration 70 allows the ladder 20 to be disposed in the cockpit 62 during missions and conveniently stored outside the aircraft 60 as needed for maintenance. If desired, two or more ladders 20 may be simultaneously used with a single aircraft 60.

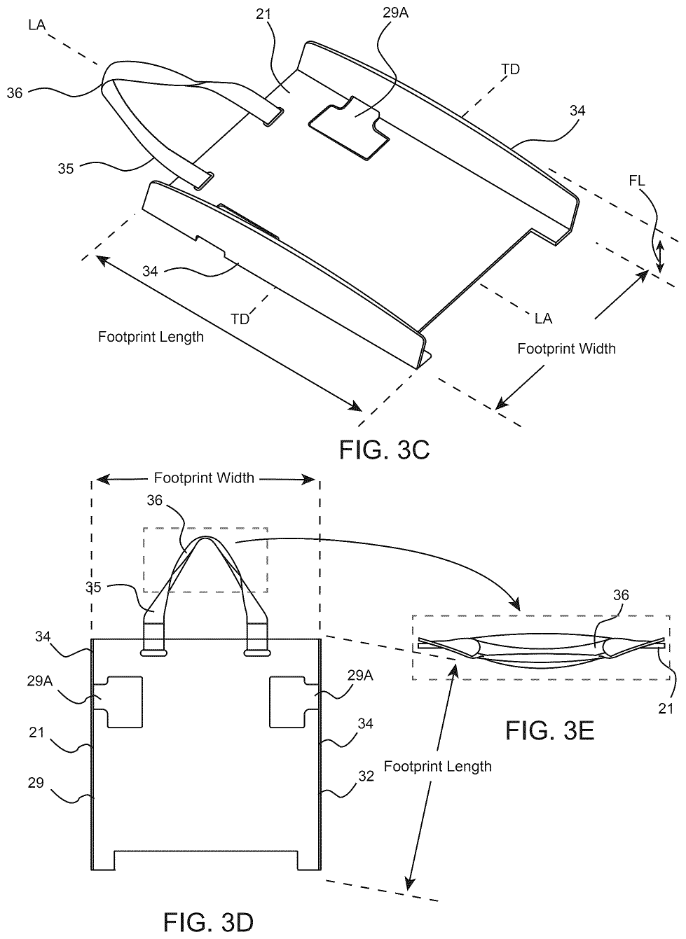

Referring to FIG. 3A-3E , the first rung plate 21 is the top rung plate 21 when the ladder 20 is in use. The first rung plate 21, or other rung plates 29 as dictated by the geometry, may have an aperture 29A therethrough. The aperture 29A provides for insertion of other components of the ladder 20 therethrough as helpful for stabilization during use.

The first rung plate 21 defines a footprint bounded by the length and width thereof. The ladder 20 may be fanfolded into this footprint. The first rung plate 21 may not have a hole 30, as the person 50 entering or leaving the cockpit 62 may use the second rung plate 22 or third rung plate 23 as the cockpit 62 is approached or departed.

The first rung plate 21 is generally planar. However the first ring plate 21 may have two transversely spaced apart flaps 34 extending from the side edges 32, so that each side edge 32 has a respective 34. Each flap 34 has a proximal end coincident the corresponding side 34 and extends to a distal end remote therefrom defining a flap length FL therebetween. The flap 34 may be generally perpendicular to the plane of the rung plate 21. The distal edge of the flap 34 may be curvilinear, particularly convex, as shown or may be rectilinear. The two flaps 34 increase the section modulus of the first rung plate 21 and transversely constrain the balance of the ladder 20 therebetween. The flaps 34 may be joined to the planar portion of the rung plate 21 by welding.

The first rung plate 21 has an attachment 35 to removably attach the ladder 20 to an anchor 64 of the aircraft 60. Particularly, the attachment 35 may removably suspend the ladder 20 to the anchor 64. A strap 36 has been found to be a suitable attachment 35. The strap 36 is lightweight, flaccid and provides dual functionality of being a handle for conveyance of the ladder 20 as a fanfold 70. Type 17 Nylon has been found suitable for the strap 36. Other suitable attachment means 35 include clevises, ropes, barbs, ties, snap closures, etc.

Referring to FIG. 3F, the first rung plate 21 may be made from a corresponding blank 21B. The blank may be stamped to provide the hole 30 if present, aperture 29A, to fold the flaps 34 in lieu of welding, etc.

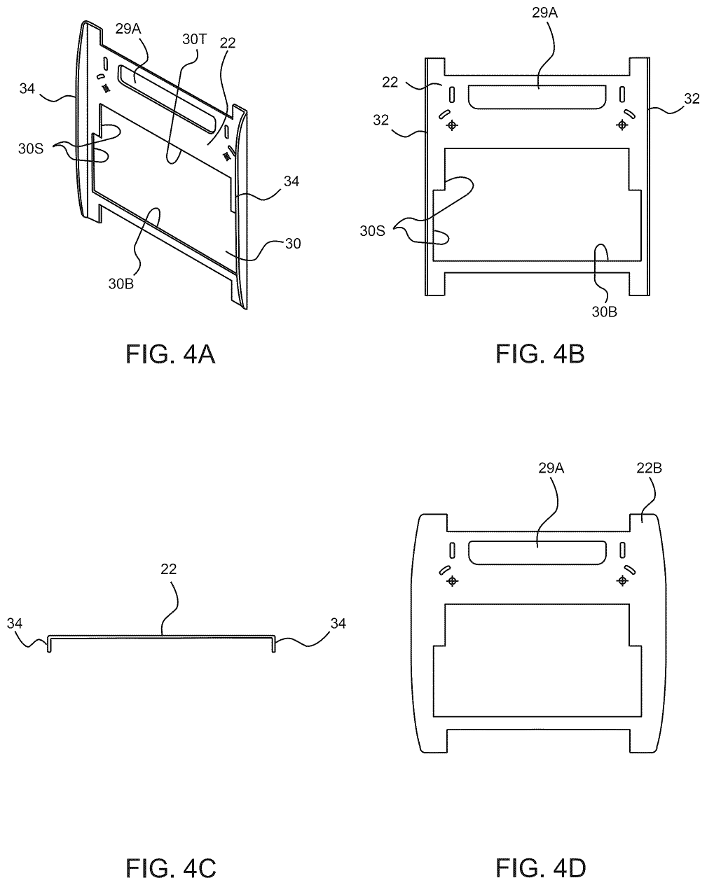

Referring to FIGS. 4A-4D, a second rung plate 22 may have a hole 30 therethrough, as described above for receiving a foot. The hole 30 has a bottom edge 30B, a top edge 30T longitudinally opposed thereto and two transversely opposed side edges 30S. The hole 30 may be generally rectangular as shown or any other suitable shape which allows the rung plate 22 to bear the weight of a person 50 thereon. The second rung plate 22 may also have an aperture 29A for insertion of other components therethorugh, particularly hardware for a standoff 41, as described below and preferably also has transversely spaced flaps 34 as described above. The second rung plate 22 may also be made from a blank 22B.

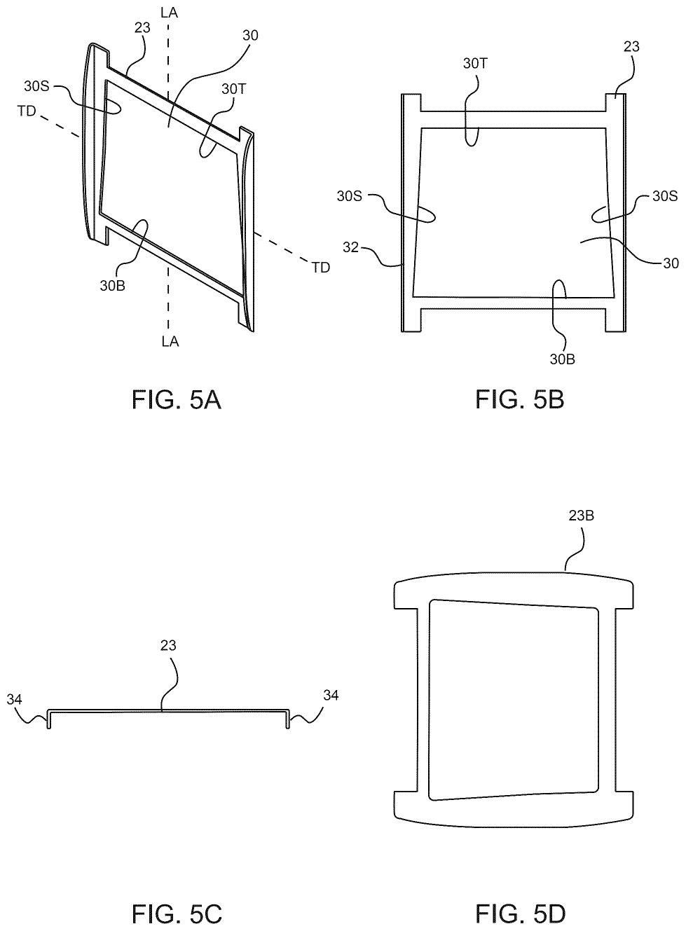

Referring to FIGS. 5A-5D, the third rung plate 23 may have a large hole 30 therethough to conserve weight and to accommodate a lock plate 40 as described below. The third rung plate 23 preferably also has flaps 34 as described above. The third rung plate 23 may also be made from a blank 23B.

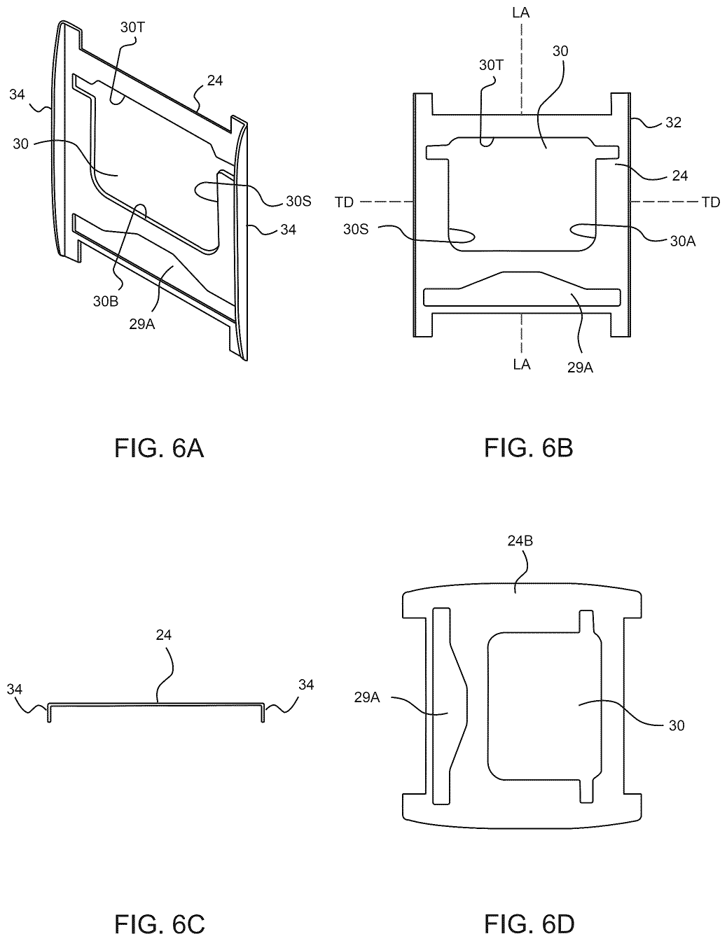

Referring to FIGS. 6A-6D, the fourth rung plate 24 may have a hole 30 therethough as described above and an aperture 29A to accommodate a lock plate 40 as described below. The fourth rung plate 24 preferably also has flaps 34 as described above. The fourth rung plate 24 may also be made from a blank 24B.

Referring to FIGS. 6A-6D, the fourth rung plate 24 may have a hole 30 therethough as described above and an aperture 29A to accommodate a lock plate 40 as described below. The fourth rung plate 24 preferably also has flaps 34 as described above. The fourth rung plate 24 may also be made from a blank 24B.

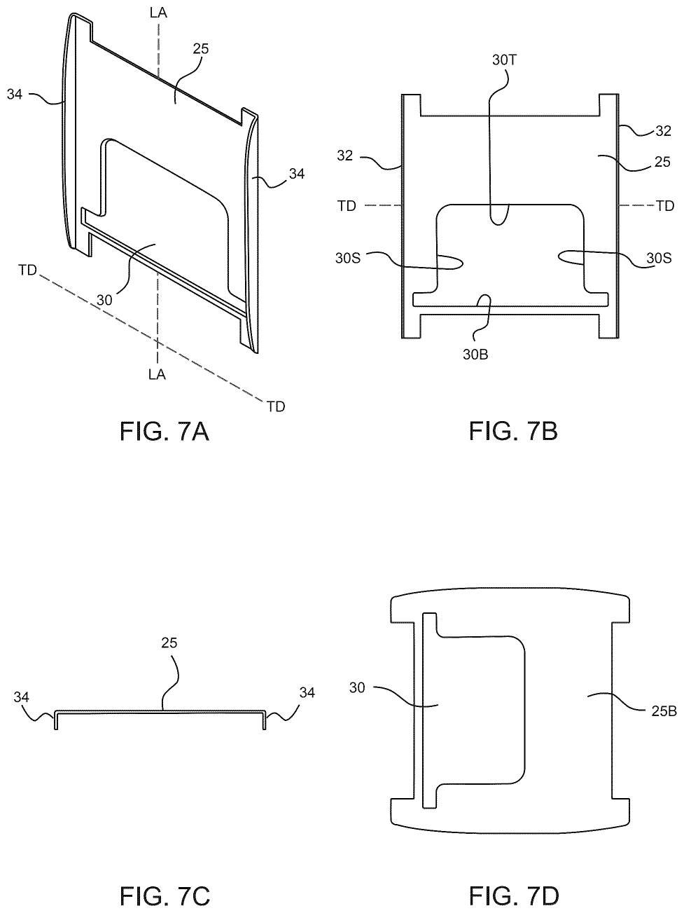

Referring to FIGS. 7A-7D, the fifth rung plate 25 may have an irregularly shaped hole 30 therethough to accommodate a lock plate 40 and/or standoff 41 in the fanfolded configuration. The fifth rung plate 25 preferably also has flaps 34 as described above. The fifth rung plate 25 may also be made from a blank 25B.

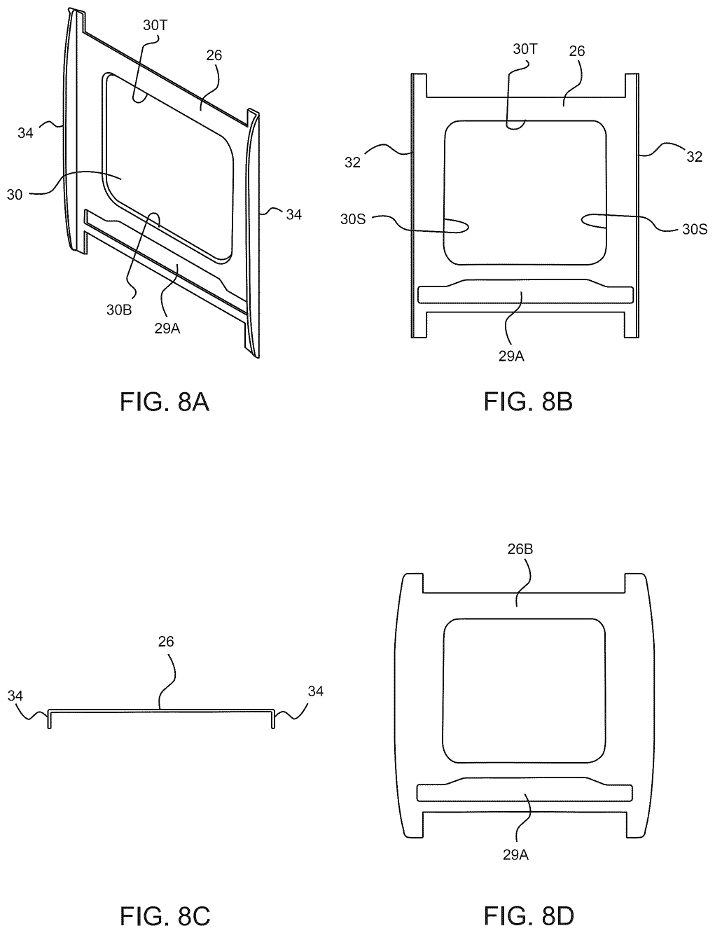

Referring to FIGS. 8A-8D, the sixth rung plate 26 may have a hole 30 therethough as described above and an aperture 29A to accommodate a lock plate 40 and/or standoff 41 as described below. The sixth rung plate 26 preferably also has flaps 34 as described above. The sixth rung plate 26 may also be made from a blank 26B.

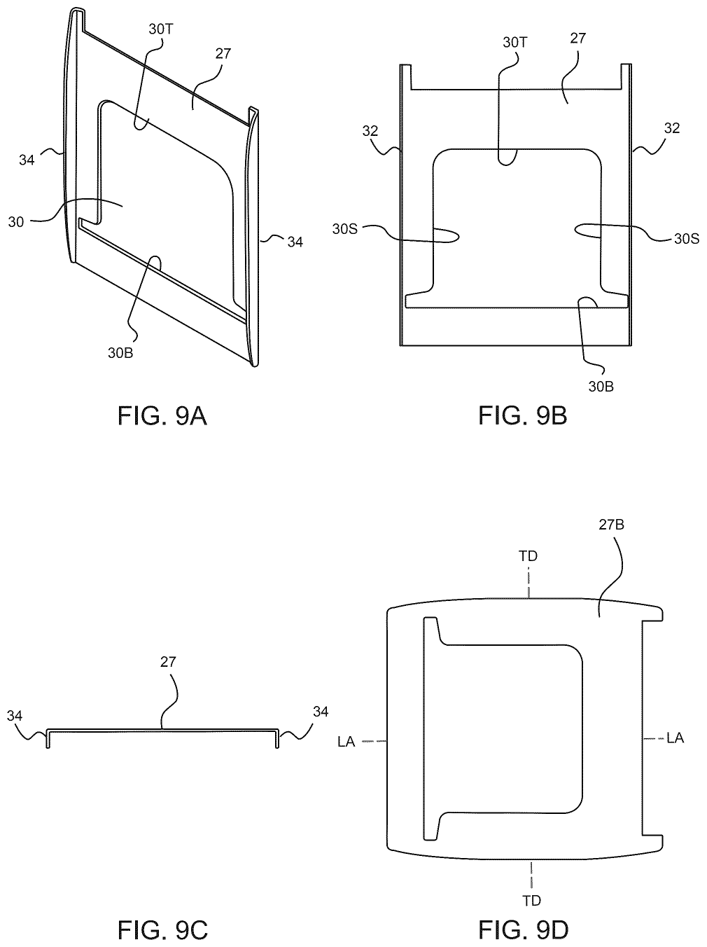

Referring to FIGS. 9A-9D, the seventh rung plate 27 may have an irregularly shaped hole 30 therethough to accommodate a lock plate 40 and/or standoff 41 in the fanfolded configuration. The seventh rung plate 27 preferably also has flaps 34 as described above. The seventh rung plate 27 may also be made from a blank 27B.

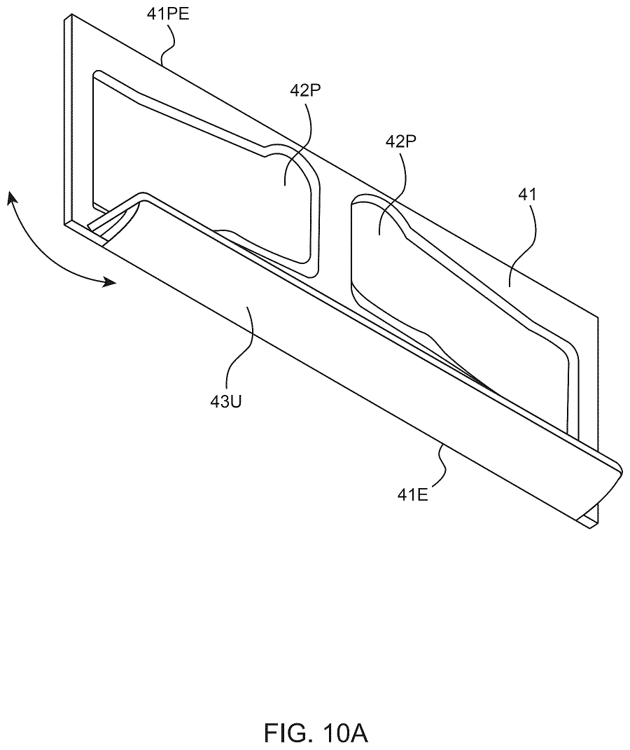

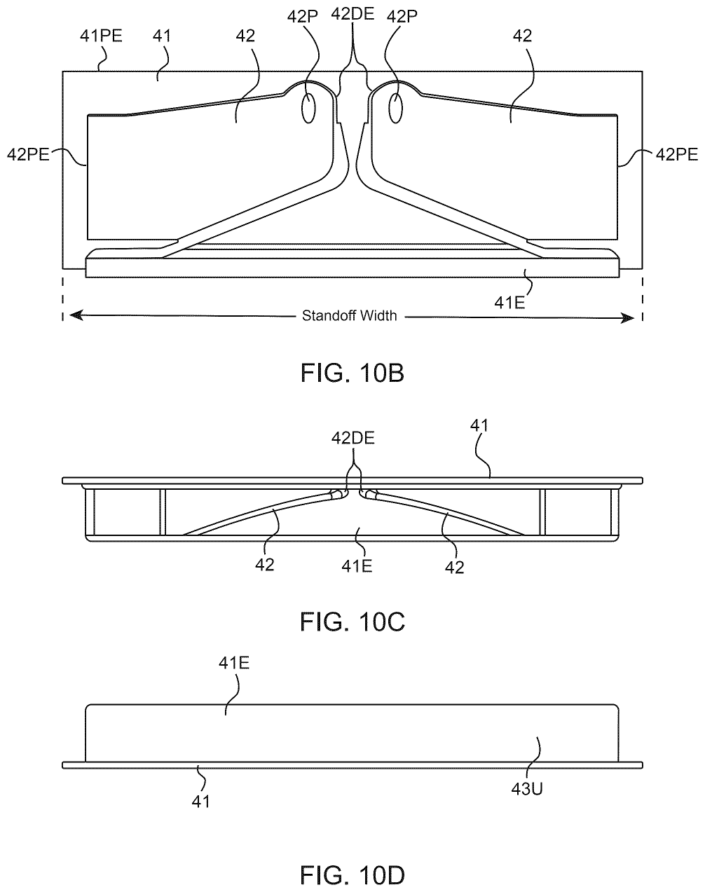

Referring to FIGS. 10A-10D, the ladder 20 preferably has a standoff 41. The standoff 41 spaces the rung plates 29 outwardly of the fuselage 61, preventing damage thereto when the ladder 20 is in use. The standoff 41 may be generally planar and formed from sheet aluminum. The standoff 41 preferably provides for single point contact against the aircraft 60, although multiple point contact is contemplated herein. The single point contact controls the disposition of the ladder 20 when in use and provides improved ergonomics during access to and egress from the cockpit 62.

The single point contact with the fuselage 61 preferably occurs at a shoe 41E which defines the distal end of the standoff 41. The shoe 41E may have the same or less width as the standoff 41, to decrease pressure under the weight of a person 50 using the ladder 20. The shoe 41E may have a depth sufficient to increase the surface area of the shoe 41E, decreasing the pressure. The shoe 43E may have a convex outwardly facing surface 43U to accommodate different placements against the strake 63. The shoe 41E is preferably padded in known fashion, to prevent damage to the fuselage 61.

The standoff 41 may be retracted to fit within the footprint and macroscopic plane of the ladder 20 when fanfolded, without increasing the thickness of the ladder 20. The standoff 41 preferably articulates outwardly from a proximal end 41PE operably associated with the second rung plate 22 or third rung plate 23, as desired, when the ladder 20 is extended for use. The standoff 41 may articulate about a proximal edge 41PE generally parallel to the hinges 33 joining the rung plates 29.

When the standoff 41 is articulated to an extended position, the shoe 41E may provide the single point contact against the fuselage 61. Preferably the standoff 41 has one or more struts 42 which provide stability in use and particularly prevent unintended collapse and retraction of the standoff 41 during use. The struts 42 articulate about a proximal end 42PE.

When the ladder 20 is fanfolded, the struts 42 may be nested in ports 42P which in the respective rung plate 29 from which the standoff 41 is articulated. The struts 42 may preferably articulate outwardly from one face of the standoff 41 or alternatively may articulate from the same rung plate 29 as the standoff 41.

When extended, the struts 42 may be generally perpendicular to the standoff 41 and/or respective rung plate 29. The struts 42 brace the standoff 41 against the rung plate 29 to prevent collapse during use and unintended contact of the ladder 20 against the aircraft 60 due to the shifting weight of the person 50 during access and egress.

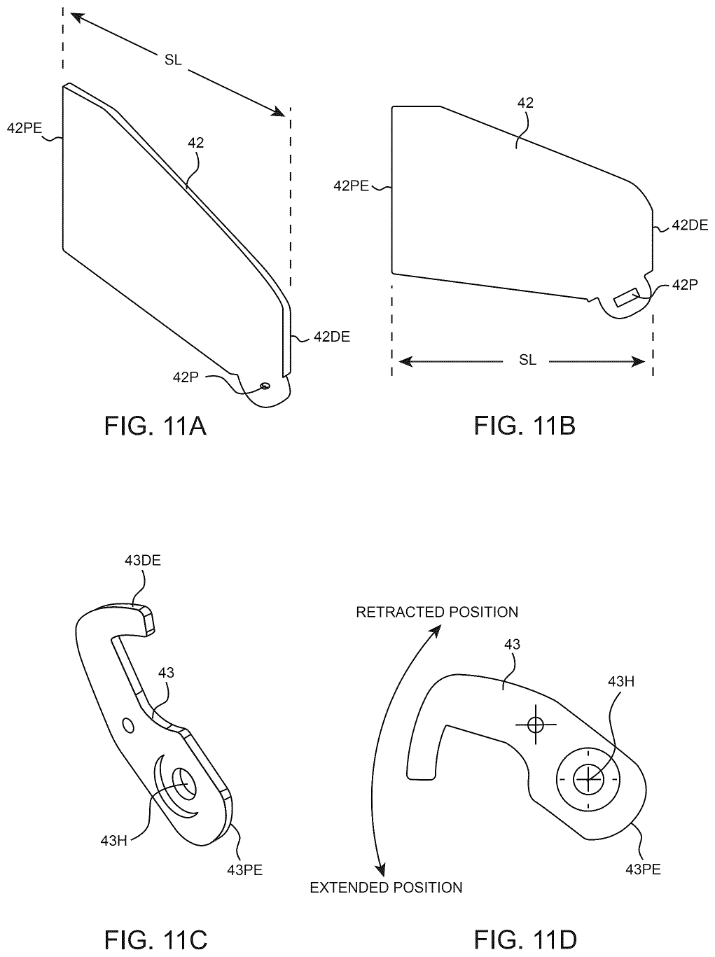

Referring to FIGS. 11A and 11B, each strut 42 has a distal end 42DE spaced apart from the respective proximal end 42PE of the strut 42 and defining a strut length SL therebetween. The distal end 42DE of each strut 42 may penetrate an aperture 29A in the corresponding rung plate 29. This configuration advantageously further improves the stability of the standoff 41 by reducing opportunity for unintended collapse of the struts(s) 42 and concomitant collapse of the standoff 41.

Referring to FIGS. 11C and 11D, stability of the struts 42, and thus stability 41 of the standoff 41 can be further improved by a latch 43 which can secure the strut 42 and particularly the distal end 42DE thereof in position. The latch 43 extends from a proximal end 43PE to a distal end 43DE remote therefrom and defining a latch 43 length therebetween. The latch 43 pivots about a pivot 43H. The pivot 43H may be juxtaposed with the proximal end 43PE of the latch 43. A pin may be used for articulation of the latch 43.

Particularly, the latch 43 may articulate from a retracted position where the latch 43 does not interact with the respective strut 42 to an extended position. In the extended position the latch 43, and particularly the distal end 43DE thereof may intercept the strut 42, particularly the distal end 42DE thereof. More particularly, as the distal end 42DE of the strut 42 protrudes through the respective rung plate 29 the port 42P juxtaposed with the distal end 42DE of the strut 42 is exposed. The latch 43 pivots to the extended position, so that the distal end 43DE thereof is inserted into the port 42P.

The extended latch 43 prevents collapse of the strut 42 under the shifting weight of the person 50, and prevents concomitant collapse of the standoff 41 and corresponding damage to the aircraft 60. This configuration adds yet additional stability to the ladder 20 when in use.

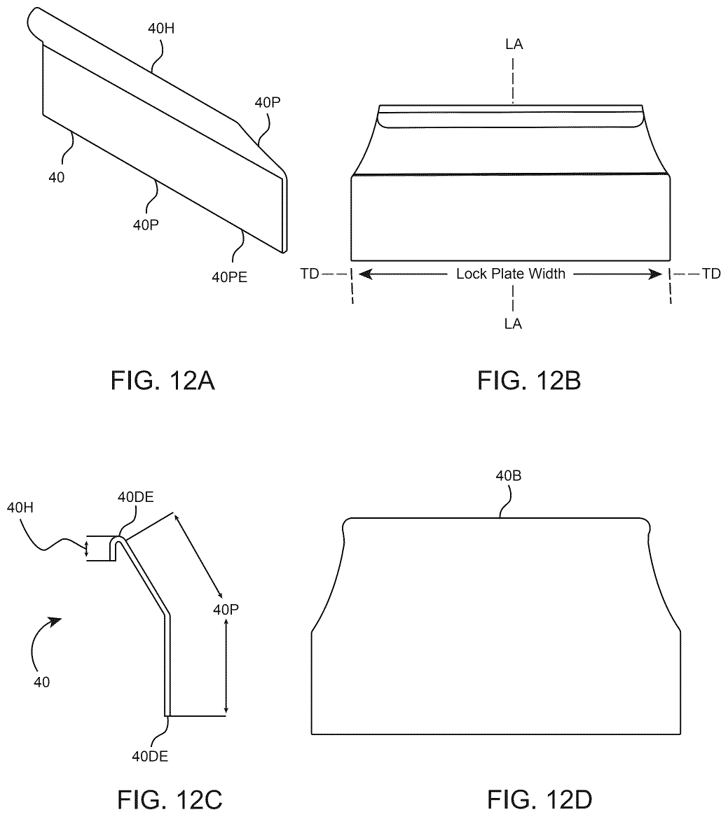

Referring to FIGS. 12A-12D, the standoff 41 may be augmented with a lock plate 40. The lock plate 40 secures adjacent rung plates 29, typically the second and third rung plates 22, 23, in obtuse angular relationship. This arrangement provides the benefit that rung plates 29 below the lock plate 40 can be vertically suspended while rung plates 29 above the lock plate 40 can be angled to prevent contact with the aircraft 60 except at the standoff 41. Functionally the lock plate 40 prevents a person 50 from swinging underneath the fuselage 61, and particularly a strake 63 thereof, while ascending or descending the ladder 20, thereby unexpectedly improving safety and ergonomics.

The lock plate 40 is comprised of plural panels 40P joined in fixed obtuse angular relationship. The panels 40P determine the corresponding angular relationship of the rung plates 29 above and below the lock plate 40. A hook 40H is joined to the uppermost panel 40P.

The lock plate 40 articulates from a proximal end 40PE articulably joined to a respective rung plate 29. The hook 40H defines the distal end 40DE of the lock plate 40 and can be removably joined to a superjacent rung plate 29.

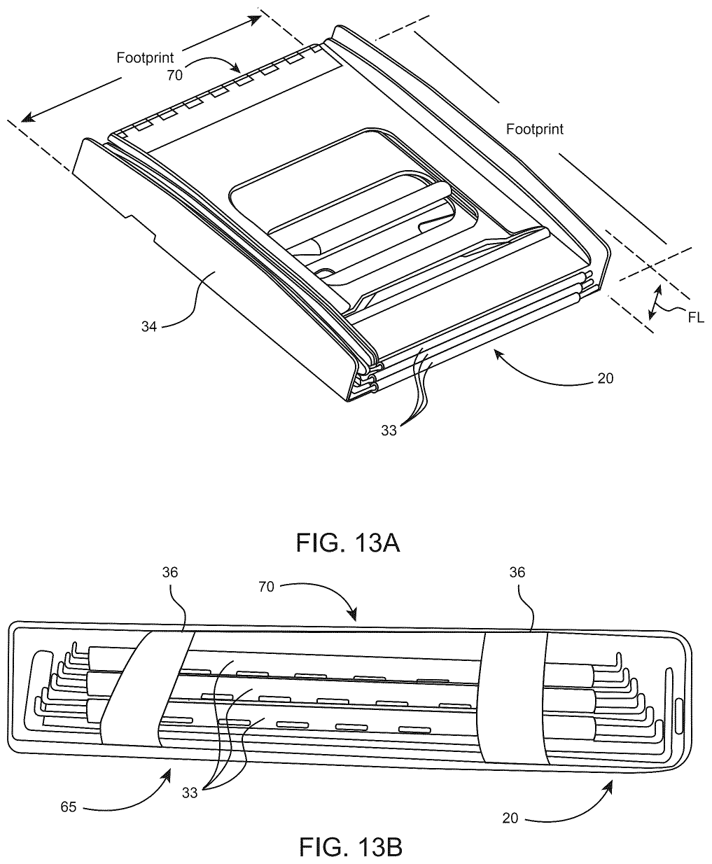

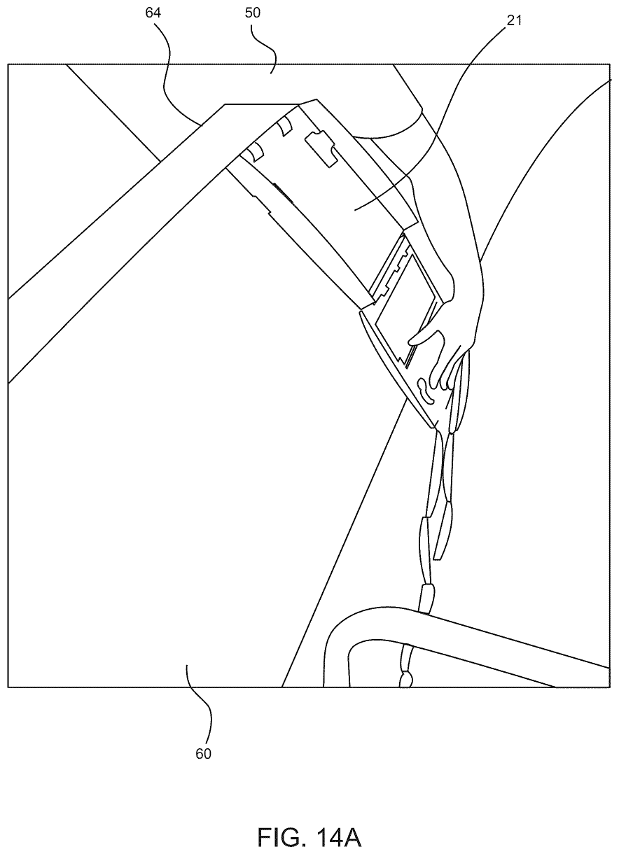

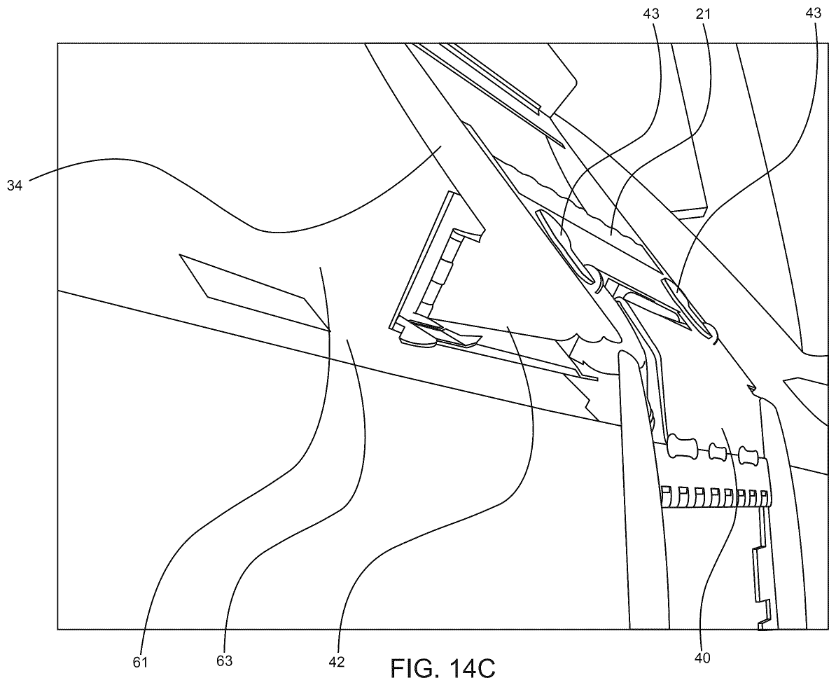

Referring to FIGS. 13A and 13B, the ladder 20 in both the extended configuration and fanfold configuration has mutually perpendicular X, Y and Z axes defining respective X, Y and Z directions. A ladder 20 in a fanfold 70 defines a footprint. The footprint defines the mutually perpendicular X-Y planar dimensions of the ladder 20. The Z direction is perpendicular to the XY plane and defines the thickness of the ladder 20 in a fanfold 70. The ratio of the X to Z dimensions of the ladder 20 define the aspect ratio thereof. The ladder 20 may have a fanfold 70 with an aspect ratio of 4:1 to 8:1, preferably 5:1-7:1 and more preferably 6:1 to 6.5:1.

The fanfold 70 provides for convenient transport and storage of the ladder 20. For example, such ladder 20 may be stored in the cockpit 62. Particularly such ladder 20 may be stored in the map compartment 65 of the cockpit 62. The map compartment 65 has a thickness of about 2 inches. Therefore it is desirable that the fanfold 70 have a thickness less than 2 inches to provide for convention insertion into, storage with and removal from the map compartment 65 62.

This arrangement provides for convenient use of the ladder 20. The ladder 20 can be suspended from an anchor 64 inside the cockpit 62. The ladder 20 can be removed from the anchor 64 by a person 50 on the ground or a person 50 in the cockpit 62 with a lift and tug motion. The removable suspension of the ladder 20 is particularly feasible when a strap 36 is used for the attachment 35. In either situation, the ladder 20 can easily be moved to another location by transport in the map compartment 65 or by hand-carry on the ground.

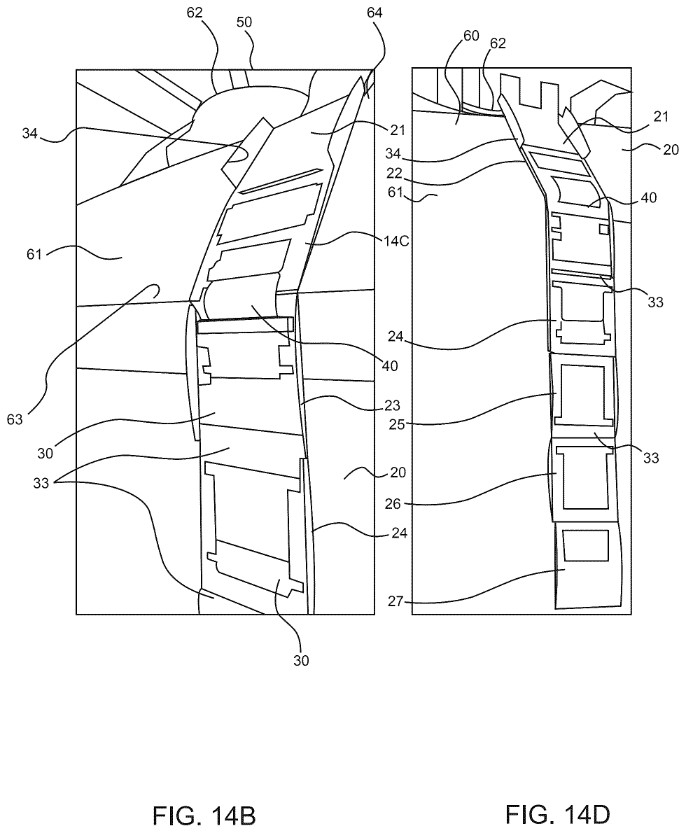

Referring to FIGS. 14A-14D, in use the ladder 20 to is removably attached to and suspended from the aircraft 60 by the attachment 35. The standoff 41 is articulably joined to the second rung plate 22 and shown in an extended position with the shoe 41S against the fuselage 61 and juxtaposed with the top of the strake 63. The inside facing surfaces of first rung plate 21 and second rung plate 22 are both in obtuse angular relationship relative to the vertical. The first rung plate 21 and second rung plate 22 are not necessarily coplanar due to the hinge 33 therebetween.

The third rung plate 23, fourth rung plate 24 and any rung plate 29 therebelow are substantially vertical. A person 50 climbing into or out of the cockpit 62 may use the second rung plate 22 or third rung plate 23 as the top step. The second rung plate 22 and third rung plate 23 have a hole 30 which allows the person 50 to insert a foot therethrough. The first rung plate 21 need not have a hole 30, to provide for protection of lower rung plates 29 fanfolded thereagainst. Optionally the first rung plate 21 may have a hole 30, to conserve weight.

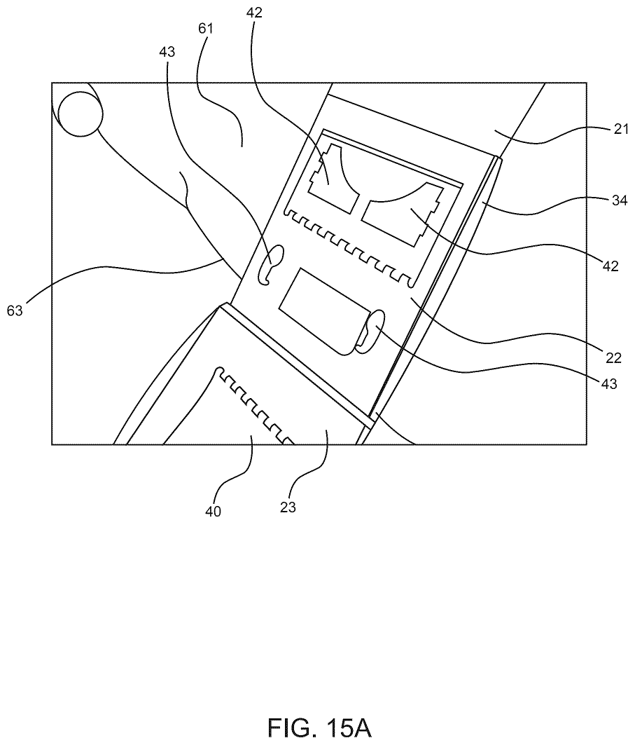

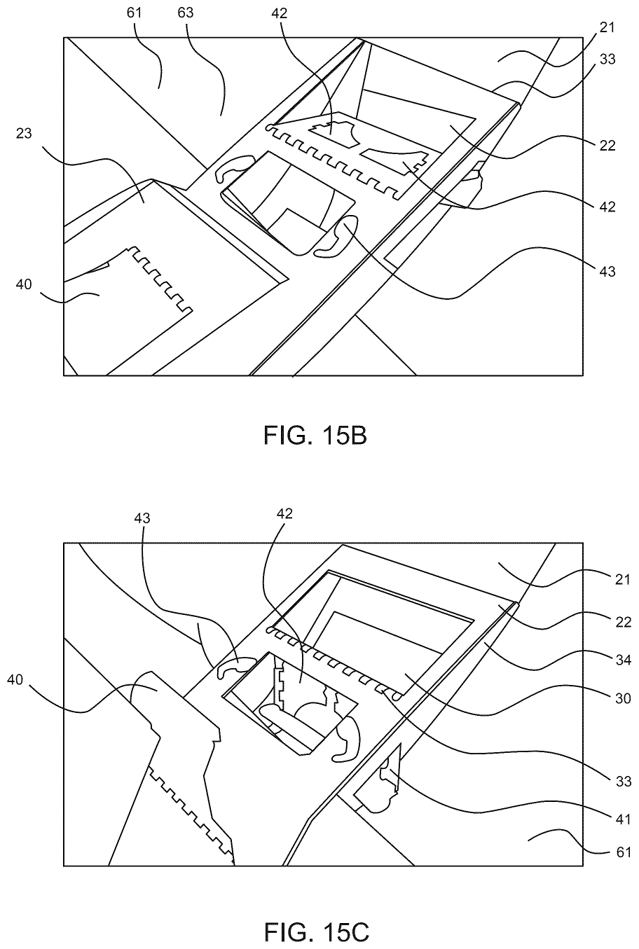

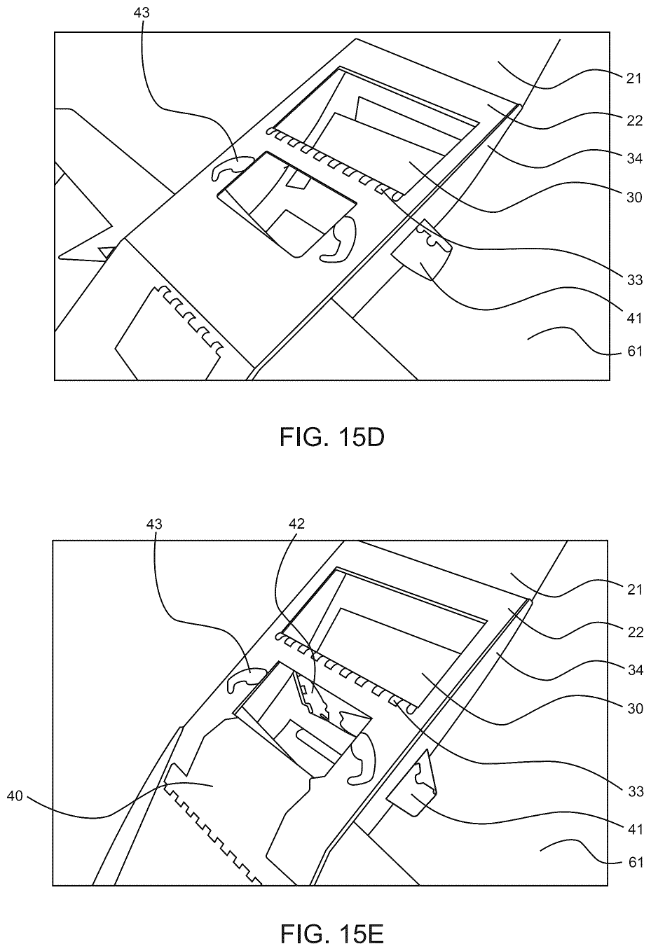

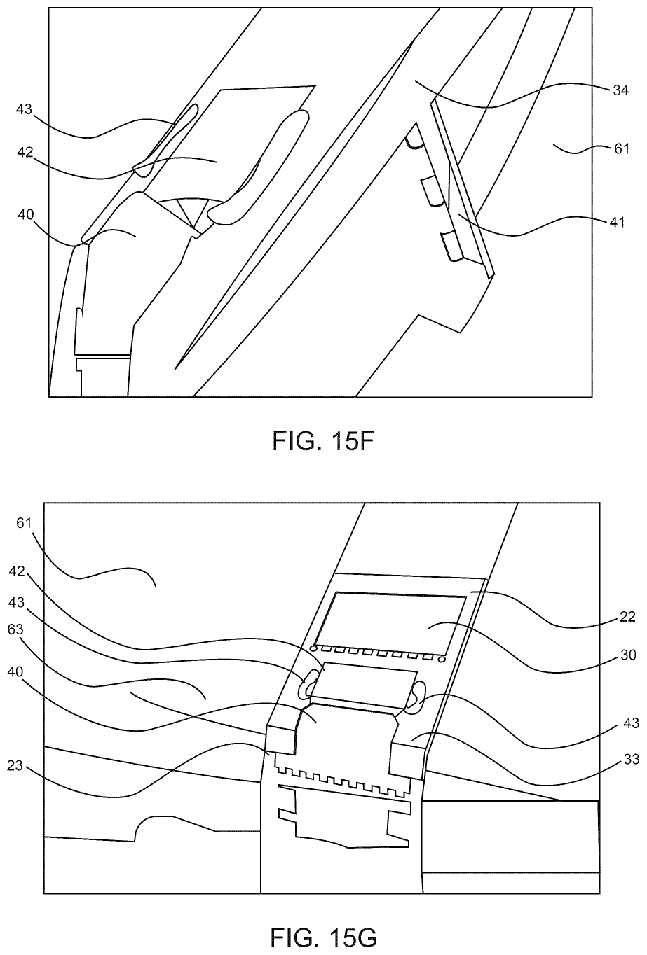

Referring to FIGS. 15A-15G, and examining the use of the ladder 20 in more detail the ladder 20 may first be suspended to relieve the weight. Then, with the weight relieved, the other components of the ladder 20 may be deployed.

Referring particularly to FIG. 15A, when the ladder 20 is initially removably attached to the anchor 64 and suspended therefrom, each rung plate 29 may be substantially flat and planar, except for the flaps 34. Similarly, the lock plate 40, standoff 41, struts 42 and flaps 43 may be generally planar with their respective rung plates 29.

Referring to FIG. 15B, the standoff 41 is articulated about the proximal end 41PE so that the outwardly facing surface 43U of the shoe 41E approaches the fuselage 61 from the side. The struts 42 are planar with the standoff 41 during this step.

Referring to FIG. 15C, the lock plate 40 the outwardly facing surface 43U of the shoe 41E is braced against the fuselage 61 without damage thereto. The lock plate 40 is released from the subjacent rung plate 29 for articulation outwardly of the respective rung plate 29.

Referring to FIG. 15D, the lock plate 40 may then be articulated about its proximal end 40PE from the subjacent rung plate 29. The hook 40H at the distal end 40DE of the lock plate 40 may then intercept and removably engage the bottom edge 30B of the hole 30 of the superjacent rung plate 29.

Referring to FIG. 15E, the symmetrically opposed struts 42 may then be deployed. Each strut 42 is articulated outwardly about its proximal end 42PE so that the distal end 42DE swings away from the longitudinal axis LA and towards the inside surface of the respective ring plate 29.

Referring to FIG. 15F, the distal ends 42DE of the struts 42 are inserted through complimentary and respective apertures 29A in the rung plate 29. The struts 42 are now in position to prevent collapse of the standoff 41.

Referring to FIG. 15G, the latches 43 are then articulated so that the distal ends 43DE thereof pivot towards the longitudinal axis LA. The distal end 43DE of each latch 43 is then inserted through a port 42P juxtaposed with the distal end 42DE of the respective strut 42. The latches 43, struts 42, standoff 41 and lock plate 40 are now secured in place and the ladder 20 is ready for use. To remove the ladder 20 for fanfold 70, the procedure is reversed.

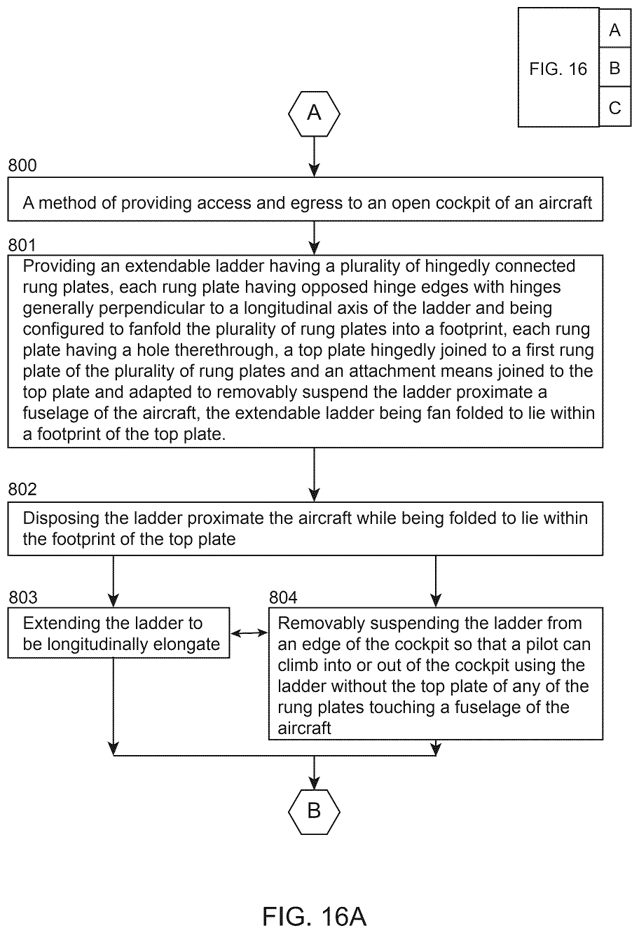

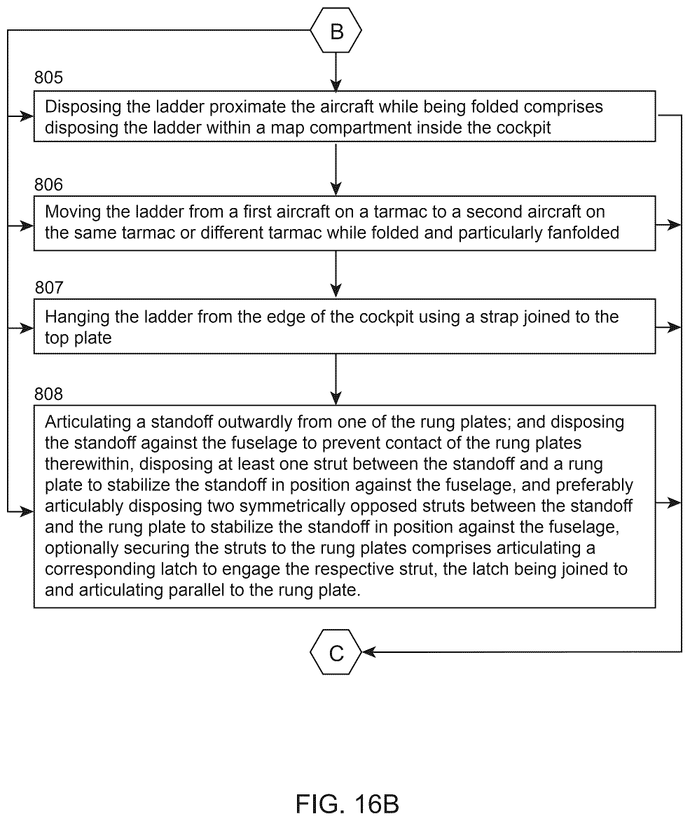

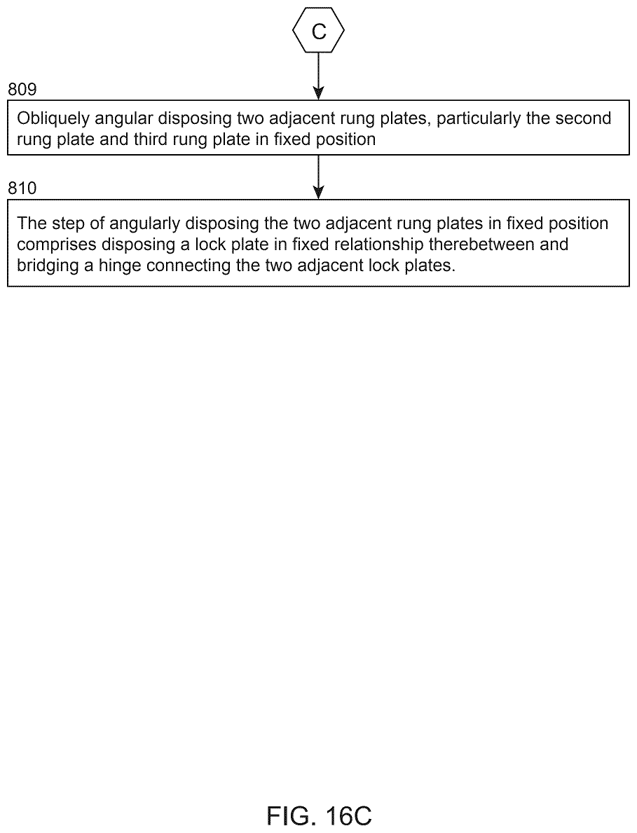

Referring to FIG. 16, in one aspect the invention comprises a method 800 of providing access and egress to an open cockpit 62 of an aircraft 60. The method 800 comprises the step 801 of providing an extendable ladder 20 having a plurality of hingedly connected rung plates 29, each rung plate 29 having opposed hinge edges 31 with hinges 33 generally perpendicular to a longitudinal axis LA of the ladder 20 and being configured to fanfold the plurality of rung plates 29 into a footprint, each rung plate 29 having a hole therethrough, a first rung plate 21 hingedly joined to a second rung plate 22 of the plurality of rung plates 29 and an attachment 35 joined to the first rung plate 21 and adapted to removably suspend the ladder 20 proximate a fuselage 61 of the aircraft 60, the extendable ladder 20 being fanfolded to lie withing a footprint of the first rung plate 21. The method 800 may further comprise the step 802 of disposing the ladder 20 proximate the aircraft 60 while being folded to lie within the footprint of the first rung plate 21.

The method 800 may further comprise the step 803 of extending the ladder 20 to be longitudinally elongate and the step 804 of removably suspending the ladder 20 from an edge of the cockpit 62 so that a pilot can climb into or out of the cockpit 62 using the ladder 20 without the first rung plate 21 or any of the rung plates 29 touching a fuselage 61 of the aircraft 60, wherein either of these steps 803, 804 can be performed before or after the other step 803, 804.

The method 800 may further comprise the step 805 of disposing the ladder 20 proximate the aircraft 60 while being folded comprises disposing the ladder 20 within a map compartment 65 inside the cockpit 62, the step 806 of moving the ladder 20 from a first aircraft 60 on a tarmac to a second aircraft 60 on the same tarmac or different tarmac while folded and particularly fanfolded and the step 807 of hanging the ladder 20 from the edge of the cockpit 62 using a strap 36 joined to the first rung plate 21.

The method 800 may further comprise the step 808 of articulating a standoff 41 outwardly from one of the rung plates 29, disposing the standoff 41 against the fuselage 61 to prevent contact of the rung plates 29 therewith, wherein disposing at least one strut 42 between the standoff 41 and a rung plate 29 to stabilize the standoff 41 in position against the fuselage 61, and preferably articulably disposing two symmetrically opposed struts 42 between the standoff 41 and the rung plate 29 to stabilize the standoff 41 in position against the fuselage 61 and optionally securing the struts 42 to the rung plates 29 comprises articulating a corresponding latch 43 to engage the respective strut 42, the latch 43 being joined to and articulating parallel to the rung plate 29.

The method 800 may further comprise the step 809 of obliquely angular disposing two adjacent rung plates 29, particularly the second rung plate 22 and third rung plate 23 in fixed position and more particularly 810 the step of angularly disposing the two adjacent rung plates 29 in fixed position comprises disposing a lock plate 40 in fixed relationship therebetween and bridging a hinge 33 connecting the two adjacent lock plates 40.

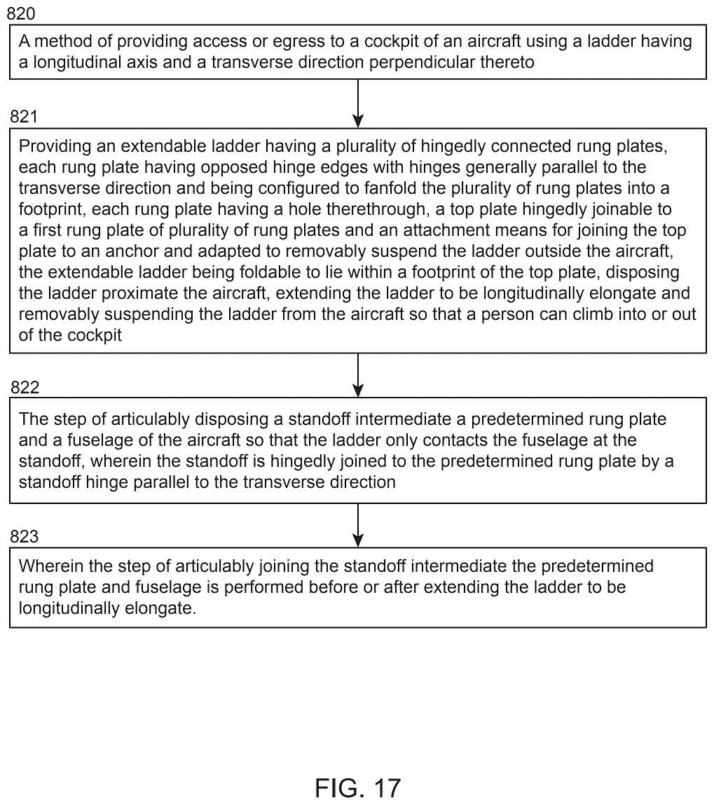

Referring to FIG. 17, in one aspect the invention comprises a method 820 of providing access or egress to a cockpit 62 of an aircraft 60 using a ladder 20 having a longitudinal axis LA and a transverse direction TD perpendicular thereto. The method 820 comprises the step 821 of providing an extendable ladder 20 having a plurality of hingedly connected rung plates 29, each rung plate 29 having opposed hinge edges 31 with hinges 33 generally parallel to the transverse direction TD and being configured to fanfold the plurality of rung plates 29 into a footprint, each rung plate 29 having a hole 30 therethrough, a first rung plate 21 hingedly joinable to a second rung plate 22 of the plurality of rung plates 29 and an attachment 35 for joining the first rung plate 21 to an anchor 64 and adapted to removably suspend the ladder 20 outside the aircraft 60, the extendable ladder 20 being foldable to lie withing a footprint of the first rung plate 21, disposing the ladder 20 proximate the aircraft 60, extending the ladder 20 to be longitudinally elongate and removably suspending the ladder 20 from the aircraft 60 so that a person 50 can climb into or out of the cockpit 62.

The step 822 of articulably disposing a standoff 41 intermediate a predetermined rung plate 29 and a fuselage 61 of the aircraft 60 may be performed so that the ladder 20 only contacts the fuselage 61 at the standoff 41, wherein the standoff 41 is hingedly joined to the predetermined rung plate 29 and optionally so that the standoff 41 is hingedly joined to the predetermined rung plate 29 by a standoff 41 hinge parallel to the transverse direction TD. The step 823 may be performed wherein the step of articulably joining the standoff 41 intermediate the predetermined rung plate 29 and fuselage 61 is performed either before or after extending the ladder 20 to be longitudinally elongate 803, 821.

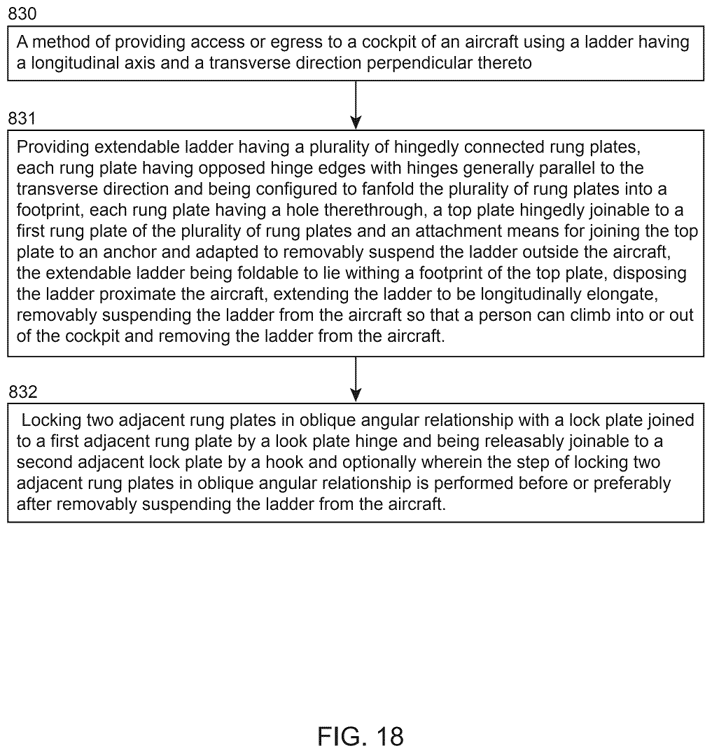

Referring to FIG. 18, in aspect the invention comprises a method 83 of providing access or egress to a cockpit 62 of an aircraft 60 using a ladder 20 having a longitudinal axis LA and a transverse direction TD perpendicular thereto. The method 830 comprises the step 831 of providing an extendable ladder 20 having a plurality of hingedly connected rung plates 29, each rung plate 29 having opposed hinge edges 31 with hinges 33 generally parallel to the transverse direction TD and being configured to fanfold the plurality of rung plates 29 into a footprint, each rung plate 29 having a hole 30 therethrough, a first rung plate 29 hingedly joinable to a second rung plate 29 of the plurality of rung plates 29 and an attachment 35 for joining the first rung plate 21 to an anchor 64 and adapted to removably suspend the ladder 20 outside the aircraft 60, the extendable ladder 20 being foldable to lie withing a footprint of the first rung plate 21, disposing the ladder 20 proximate the aircraft 60, extending the ladder 20 to be longitudinally elongate, removably suspending the ladder 20 from the aircraft 60 so that a person 50 can climb into or out of the cockpit 62 and removing the ladder 20 from the aircraft 60. This method 830 may further comprises the step 832 of locking two adjacent rung plates 29 in oblique angular relationship with a lock plate 40 joined to a first adjacent rung plate 29 by a lock plate 40 hinge and being releasably joinable to a second adjacent lock plate 40 by a hook 40H and optionally locking two adjacent rung plates 29 in oblique angular relationship before or preferably after removably suspending the ladder 20 from the aircraft 60.

One of skill will recognize that the ladder 20 according to the present invention may be used for other purposes such as a fire escape device hanging out a building window, for construction suspended from a joist, etc.

All values disclosed herein are not strictly limited to the exact numerical values recited. Unless otherwise specified, each such dimension is intended to mean both the recited value and a functionally equivalent range surrounding that value. For example, a dimension disclosed as “40 mm” is intended to mean “about 40 mm.” The term “or” as used herein is to be interpreted as an inclusive or meaning any one or any combination. Therefore, “A, B or C” means “any of the following: A; B; C; A and B; A and C; B and C; A, B and C.” Every document cited herein, including any cross referenced or related patent or application, is hereby incorporated herein by reference in its entirety unless expressly excluded or otherwise limited. The citation of any document or commercially available component is not an admission that such document or component is prior art with respect to any invention disclosed or claimed herein or that alone, or in any combination with any other document or component, teaches, suggests or discloses any such invention. Further, to the extent that any meaning or definition of a term in this document conflicts with any meaning or definition of the same term in a document incorporated by reference, the meaning or definition assigned to that term in this document shall govern according to Phillips v. AWH Corp., 415 F.3d 1303 (Fed. Cir. 2005). All limits shown herein as defining a range may be used with any other limit defining a range of that same parameter. That is the upper limit of one range may be used with the lower limit of another range for the same parameter, and vice versa. As used herein, when two components are joined or connected the components may be interchangeably contiguously joined together or connected with an intervening element therebetween. A component joined to the distal end of another component may be juxtaposed with or joined at the distal end thereof. While particular embodiments of the present invention have been illustrated and described, it would be obvious to those skilled in the art that various other changes and modifications can be made without departing from the spirit and scope of the invention and that various embodiments described herein may be used in any combination or combinations. It is therefore intended the appended claims cover all such changes and modifications that are within the scope of this invention.

What is claimed is:

1. An open cockpit aircraft in combination with a non-self-supporting ladder for access thereto and egress therefrom and comprising:
the aircraft having a fuselage and an anchor proximate thereto; and
the longitudinally elongatable ladder comprising a plurality of hingedly connected rung plates, each rung plate having two opposed hinge edges with hinges disposed thereon and configured to fanfold the plurality of rung plates into a footprint, each rung plate having a hole therethrough; and
a first rung plate joined to a second rung plate of the plurality of rung plates, the first rung plate having an attachment for suspending the ladder from the anchor.

2. An open cockpit aircraft in combination with a non-self-supporting ladder according to claim 1 wherein the ladder is fanfoldable and sized to fit within a map compartment disposed within the cockpit of the open cockpit aircraft.

3. An open cockpit aircraft in combination with a non-self-supporting ladder according to claim 2 wherein each rung plate of the plurality of rung plates has opposed side edges connecting the respective hinge edges, and each of the opposed side edges having a flap extending outwardly from a proximal edge joined to one of the side edges to a distal edge remote therefrom.

4. An open cockpit aircraft in combination with a non-self-supporting ladder according to claim 3 wherein the flaps have a flap length extending from the proximal edge to the distal edge, the flap length encompassing the ladder when in a fanfolded configuration.

5. An open cockpit aircraft in combination with a non-self-supporting ladder according to claim 4 wherein the attachment comprises a loop strap.

6. An open cockpit aircraft in combination with a non-self-supporting ladder according to claim 5, the ladder further comprising at least one standoff, the at least one standoff being articulably joined to a respective rung plate, the at least one standoff being configured to articulate flat against the respective rung plate when the ladder is not in use and to articulate outwardly against the fuselage to space the plurality of rung plates away from the fuselage of the aircraft when the ladder is in use.

7. An open cockpit aircraft in combination with a non-self-supporting ladder according to claim 1 wherein the ladder is in a longitudinally elongate configuration and removably attached to an anchor in the cockpit by the loop strap.

8. An open cockpit aircraft in combination with a non-self-supporting ladder for access thereto and egress therefrom and comprising:
a ladder removably joinable to the outside of an aircraft to provide personnel access and egress into and out of a cockpit thereof and having a longitudinal axis and a transverse direction perpendicular thereto:
the aircraft having a fuselage, an anchor proximate thereto and an external strake; and
the ladder comprising a plurality of hingedly connected rung plates, each rung plate having two opposed hinge edges with hinges disposed thereon and configured to fanfold the plurality of rung plates into a footprint, each rung plate having two opposed side edges connecting the two opposed hinges edges to define a respective footprint therebetween, and a hole therethrough for accepting a person's foot when climbing up or down the ladder, a second rung plate of the plurality of rung plates being hingedly joined to the first rung plate, the other rung plates successively depending from the second rung plate; and
a respective rung plate having a standoff joined thereto and being disposed wholly within the footprint, whereby the ladder is removably suspendable from the cockpit with only a single, predetermined contact with a fuselage of the aircraft at the standoff.

9. An open cockpit aircraft in combination with a non-self-supporting ladder according to claim 8 wherein the standoff articulates about a standoff hinge proximate a lower edge of the respective rung plate inwardly towards the fuselage of the aircraft to a standoff extended configuration when the ladder is suspended from the anchor to thereby dispose the standoff against the fuselage.

10. An open cockpit aircraft in combination with a non-self-supporting ladder according to claim 9 wherein the ladder is disposed outwardly of and does not contact the strake of the fuselage when the ladder is suspended from the anchor.

11. An open cockpit aircraft in combination with a non-self-supporting ladder according to claim 10 wherein the standoff is generally planar and further comprising a pair of mutually opposed struts hingedly joined thereto at a proximal end and foldable against the plane of the standoff for operatively connecting the standoff to the respective rung plate in a bistable open position.

12. An open cockpit aircraft in combination with a non-self-supporting ladder according to claim 11 further comprising a lock plate connecting two adjacent rung plates, the lock plate having two panels joined at an oblique included angle and being articulable from one of the adjacent rung plates to be releasably lockable to the other of the adjacent rung plates and thereby maintain the oblique included between the two adjacent rung plates when a person is using the ladder.

13. An open cockpit aircraft in combination with a non-self-supporting ladder according to claim 12 wherein each strut extends from a respective proximal end to a respective distal end, each distal end being outwardly extendable to be removably attachable to the respective rung plate and further comprising a pair of latches operably associated with the respective rung plate having the struts extending outwardly therefrom and configured to releasably secure the distal ends of the struts to the respective rung plate.

14. An open cockpit aircraft in combination with a non-self-supporting ladder according to claim 13 wherein the ladder is in a longitudinally elongate configuration and removably attached to an anchor in the cockpit by the loop strap.

15. An open cockpit aircraft in combination with a non-self-supporting ladder for access thereto and egress therefrom and comprising:
the aircraft having a fuselage and an anchor proximate thereto; and
at least two hingedly connected rung plates, each of the at least two rung plates having a hole therethrough, the hole having a bottom edge configured to allow a person's foot to temporarily rest thereupon;
a standoff joined to a predetermined, generally planar rung plate by a standoff hinge, whereby the standoff can articulate from a standoff retracted position generally lying within the plane of the predetermined, generally planar rung plate to a standoff extended position for preventing the ladder from contacting a fuselage except at the standoff, whereby the rung plates can fold into a fanfold footprint when the standoff is in the retracted position; and
at least two hingedly connected rung plates, each of the at least two rung plates having a hole therethrough for accepting a person's foot during climbing and having opposed inward and outward faces;
a standoff joined to a predetermined, generally planar rung plate by a standoff hinge, whereby the standoff can articulate from a standoff retracted position generally lying within the plane of the predetermined, generally planar rung plate to a standoff extended position for preventing the ladder from contacting a fuselage except at the standoff, whereby the rung plates can fold into a fanfold footprint when the standoff is in the retracted position;
a pair of mutually opposed struts lying within the plane of the predetermined, generally planar rung plate in a strut retracted position and extending outwardly towards the fuselage in a strut extended position, whereby the ladder is fanfoldable into a footprint no bigger than the footprint of the largest rung plate; and
a means to suspend the rung plates from an anchor associated with an aircraft.

16. An open cockpit aircraft in combination with a non-self-supporting ladder according to claim 15 further comprising a pair of latches, each latch of the pair of latches intercepting a corresponding strut on the outward face of the predetermined, generally planar rung plate.

17. An open cockpit aircraft in combination with a non-self-supporting ladder according to claim 16 wherein the mutually opposed struts are hingedly attached to the standoff.

18. An open cockpit aircraft in combination with a non-self-supporting ladder according to claim 17 wherein the struts are perpendicular to the predetermined, generally planar rung plate in the respective strut extended positions.

19. An open cockpit aircraft in combination with a non-self-supporting ladder according to claim 18 wherein the generally planar rung plate has a pair of apertures therethrough and each strut is disposed through a respective aperture and secured by a latch in the strut extended position.

20. An open cockpit aircraft in combination with a non-self-supporting ladder according to claim 19 wherein the ladder is in a longitudinally elongate configuration and removably attached to an anchor in the cockpit by the loop strap.
